(19) United States
(12) Patent Application Publication
(10) Pub. No.: US 2024/0270656 A1
(43) Pub. Date: Aug. 15, 2024

(54) MULTI-STEP METHODS OF MAKING A MULTI-PHASE MATERIAL

(71) Applicant: ADVANCED POTASH TECHNOLOGIES, LTD., Grand Cayman (KY)

(72) Inventors: Jamal Chaouki, Dorval (CA); Mohammad Latifi, Candiac (CA); Javeed Mohammad, Mississauga (CA); Mitra Mirnezami, Pierrefonds (CA)

(21) Appl. No.: 18/567,230

(22) PCT Filed: Jun. 16, 2022
(86) PCT No.: PCT/IB2022/055613

§ 371 Date: Dec. 5, 2023

Related U.S. Application Data
(60) Provisional application No. 63/214,958, filed on Jun. 25, 2021.

(51) Int. Cl. C05D 1/04; C05D 1/00; C05D 3/02

(52) U.S. Cl. CPC C05D 1/04; C05D 1/005; C05D 3/02

(57) ABSTRACT

Multi-step methods of making an MPM include at least first and second steps. The first step can be performed at relatively low temperature and/or a relatively low pressure. The second step can be performed at a relatively high temperature and/or a relatively high pressure. The first step can be performed in one or more reaction vessels. and the second step can be performed in one or more different reaction vessels.

### CROSS-REFERENCE TO RELATED APPLICATIONS

This application claims the benefit of priority to U.S. application Ser. No. 63/214,958, filed on Jun. 25, 2021, the contents of which is hereby incorporated by reference.

### FIELD

The disclosure provides multi-step methods of making a multi-phase material (MPM).

### BACKGROUND

Single-step methods of making MPMs using an autoclave are known.

### SUMMARY

The disclosure provides multi-step methods of making an MPM. Optionally, the methods can be performed with relatively lower capital expenditure and/or relatively lower operating expenditure. In some embodiments, such benefits can be achieved by using relatively inexpensive equipment. As an example, in certain embodiments, the methods are performed without using an autoclave. For example, the first step can be performed in a non-pressurized reaction vessel, which can reduce cost compared to a process that uses an autoclave. Further, the second step can be performed in a relatively inexpensive pressurized reaction vessel (e.g., a pipe reactor). In addition, an alternative pressurized reaction vessel, such as, for example, a pipe reactor, can allow for higher temperatures and resulting pressures compared to an autoclave.

In general, the methods include at least two steps. In some embodiments, the first step is performed at relatively low temperature (e.g., at most 100° C.) and/or a relatively low pressure (e.g., at most two atmospheres). The second step involves a higher temperature and/or pressure. In some embodiments, the second step is performed at a temperature of at least 180° C. and a pressure of at least five atmospheres. In certain embodiments, the first step is performed in one or more reaction vessels, and the second step is performed in one or more different reaction vessels. The first step can be performed with or without agitation. In some embodiments, the method can include more than two steps. As an example, the method can include heating to an intermediate temperature (a temperature between the lowest and highest temperatures used in the MPM formation method). In some embodiments, the method can include heating to an intermediate temperature that is at least 20° C. (e.g., at least 25° C., at least 30° C., at least 35° C., at least 40° C.) and at most 400° C. (e.g., at most 350° C., at most 300° C., at most 290° C., at most 280° C., at most 270° C., at most 250° C., at most 240° C.). This temperature can be held for a period of time as desired (e.g., at least 10 minutes, at least 30 minutes, at least one hour, at least 10 hours) and/or at most two days (e.g., at most one day, at most 20 hours), followed by heating to a higher temperature (e.g., the temperature used in the second step). In general, there is a transition between the conditions of the first step and the second step. As an example, in some embodiments, there is a transition between a temperature of at least 20° C. and a temperature of at most 400° C. As another example, in certain embodiments, there is a transition between a pressure of at most two atmospheres and a pressure of at least five atmospheres. As a further example, in some embodiments, there is a transition between both: 1) a temperature of at least 20° C. and a pressure of at most two atmospheres; and 2) a temperature of at most 400° C. and a pressure of at least five atmospheres. In some embodiments, the transition is a smooth transition between one or more (e.g., all) of the conditions of the first step and the conditions of the second step. For example, the temperature can be a smooth transition, and/or the pressure transition can be a smooth transition. In some embodiments, the transition of a condition is monotonic, e.g., a monotonic increase in temperature and/or a monotonic increase in pressure. In certain embodiments, the transition of a condition is a step-wise transition, e.g., a step-wise increase in temperature and/or a step-wise increase in pressure. Other types of transitions are also possible.

Without being bound by theory, it is believed that the conditions of the first step can allow for good mass transfer of calcium ions, possibly because calcium oxide (CaO) is more soluble under these conditions, which can allow for an initial reaction between calcium and K-feldspar to produce an intermediate product. Also without being bound by theory, it is believed that the one or more steps after the first step allow for a more efficient mineral transformation of intermediate product to an MPM. A multi-step reaction as disclosed herein may allow a cost effective and efficient balance between competing factors, such as mass transfer of calcium ions and rate of MPM formation.

In an aspect, the disclosure provides a method of making an MPM, including: a) reacting starting materials at a temperature of at most 100° C. to form intermediate products; and b) reacting the intermediate products at a temperature of at least 180° C., wherein the method makes the MPM.

In an aspect, the disclosure provides a method of making an MPM, including: a) reacting starting materials at a pressure of at most two atmospheres to form intermediate products; and b) reacting the intermediate products at a pressure of at least five atmospheres, wherein the method makes the MPM.

In an aspect, the disclosure provides a method of making an MPM, including: a) reacting starting materials to form intermediate products; and b) reacting the intermediate products without agitation, wherein the method makes the MPM.

In an aspect, the disclosure provides a method of making an MPM, including: a) reacting starting materials in a first reaction vessel to form intermediate products; and b) reacting the intermediate products in a second reaction vessel, wherein the second reaction vessel is different from the first reaction vessel, wherein the method makes the MPM.

In an aspect, the disclosure provides a method of making an MPM, including: a) reacting starting materials at a temperature of at most 100° C. to form intermediate products; and b) heating the intermediate products by a process that can include heating to a temperature of at least 180° C., wherein the method makes the MPM.

In some embodiments a) can be performed at a temperature of most 100° C. (e.g., at a temperature of at most 90° C., at most 80° C., at most 70° C., at most 60° C.) and/or a temperature of at least 20° C.

In certain embodiments, b) can be performed at a temperature of at least 180° C. (e.g., at least 200° C., at least 210° C., at least 220° C., at least 230° C., at least 240° C.) and/or at a temperature of at most 400° C.

In some embodiments, a) can be performed at a pressure of at most two atmospheres (e.g., at most 1.5 atmospheres, at most one atmosphere) and/or at a pressure of at least 0.9 atmosphere.

In certain embodiments, b) can be performed at a pressure of at least five atmospheres (e.g., at least 10 atmospheres, at least 25 atmospheres, at least 50 atmospheres) and/or at a pressure of at most 300 atmospheres.

In some embodiments, the method can further include, between a) and b), heating to a temperature of at least 180° C.

In some embodiments, the method can further include, between a) and b), heating to an intermediate temperature. Optionally, in such embodiments, a) can include heating to a first temperature, b) can include heating to a second temperature, and the intermediate temperature is between the first and second temperatures.

In certain embodiments, the method can further include, between a) and b), increasing the pressure from a pressure of at most two atmospheres to a pressure of at least five atmospheres.

In some embodiments, the method can further include, between a) and b), increasing the pressure to an intermediate pressure. Optionally, in such embodiments, a) can include using a first pressure, b) can include using a second pressure, and the intermediate pressure is between the first and second pressures.

In certain embodiments, a) can be performed in a first reaction vessel, and b) can be performed in a second reaction vessel different from the first reaction vessel.

In some embodiments, a) can be performed in a first plurality of reaction vessels, and b) can be performed in a second plurality of reaction vessels different from the first plurality of reaction vessels.

In certain embodiments, a) can include agitating the starting materials.

In some embodiments, a) does not include agitating the starting materials.

In certain embodiments, b) can include agitating the reaction products.

In some embodiments, b) does not include agitating the reaction products.

In certain embodiments, a) can be performed using a reaction vessel selected from the group including a closed tank, an open tank, a containment vessel, an open evaporation pond, tubular vessels, rotating disks, solid-liquid contactors, and hydrocyclones.

In some embodiments, b) can be performed using a reaction vessel selected from the group including an autoclave, a pipe reactor, three phase gas-liquid-solid contactors, and rotating drums.

In certain embodiments, a) can be performed for at least 15 minutes (e.g., at least 30 minutes) and/or at most two weeks (e.g., at most one week).

In certain embodiments b) can be performed for at least one minute (e.g., at least five minutes) and/or at most one week (e.g., at most 24 hours).

In certain embodiments, a) can include: a1) reacting the starting materials at a first temperature of at most 50° C. to form first materials; and a2) after a1), reacting the first materials at a second temperature which is greater than the first temperature to form the intermediate products. The first temperature can be at least 20° C., and the second temperature is at most 100° C. a1) can be performed at a temperature of at most 50° C. a2) can be performed at a temperature of at least 75° C.

In some embodiments, the method can further include, after b), drying the products of b). Drying can be performed at a temperature of at least between 25° C., and/or at a temperature of at most 400° C. Drying can occur at a pressure of at least one atmosphere, and/or at a pressure of at most 100 atmospheres.

In certain embodiments the starting materials can include a potassic framework silicate ore. The starting materials can include, for example, at least one member selected from the group including K-feldspar, kalsilite, nepheline, phlogopite, muscovite, biotite, trachyte, rhyolite, micas, ultrapotassic syenite, leucite, nepheline syenite, phonolite, fenite, aplite and pegmatite. In some embodiments, the starting materials can include K-feldspar. In certain embodiments, the starting materials can include at least one material selected from the group including an oxide, a hydroxide, and a carbonate of at least one of an alkaline earth metal and an alkali metal. In some embodiments, the starting materials can include at least two materials selected from the group including an oxide, a hydroxide and a carbonate of at least one of an alkaline earth metal and an alkali metal. In certain embodiments, the starting materials can include an oxide, a hydroxide, and a carbonate of at least one of an alkaline earth metal and an alkali metal. In some embodiments, the metal can include at least one member selected from the group including lithium (Li), sodium (Na), and potassium (K), beryllium (Be), magnesium (Mg), calcium (Ca), strontium (Sr). In certain embodiments, the starting materials can include at least one member selected from the group including CaO, Ca(OH)₂ and CaCO₃.

In some embodiments, the starting materials are provided in a single batch.

In certain embodiments, the starting materials are provided in a step-wise manner.

In some embodiments, at least one of the following holds: the starting materials can include a potassic framework silicate ore and CaO in a molar ratio of Ca:Si of between 0.05 and 4; the starting materials can include a potassic framework silicate ore and Ca(OH)₂ in a molar ratio of Ca:Si between 0.05 and 4; and the starting materials can include a potassic framework silicate ore and CaCO₃ in a molar ratio of Ca:Si between 0.05 and 4.

In certain embodiments, the starting materials can include water.

In some embodiments, the starting materials can include at least one member selected from the group including of KCl, a macronutrient source, a micronutrient source and a source of a beneficial element. The at least one member can include, for example, a member selected from the group including N, P, K, Ca, Mg, S, B, Cl, Cu, Fe, Mn, Mo, Ni, Zn, Na, Se, Si, Co and V.

In certain embodiments, the method can further include, before b), adding to the intermediate products at least one member selected from the group including KCl, a macronutrient source, a micronutrient source and a source of a beneficial element. The at least one member can include a member selected from the group including N, P, K, Ca, Mg, S, B, Cl, Cu, Fe, Mn, Mo, Ni, Zn, Na, Se, Si, Co and V.

In some embodiments, the MPM can include at least two phases (e.g., at least three phases, at least four phases) selected from the group including K-feldspar phase, tobermorite phase, hydrogrossular phase, dicalcium silicate hydrate phase and amorphous phase.

In certain embodiments, the MPM can include K-feldspar phase, tobermorite phase, hydrogrossular phase, dicalcium silicate hydrate phase and amorphous phase.

In some embodiments, the MPM can include at least 1% by weight of K-feldspar phase, and/or at most 74.5% by weight of K-feldspar phase.

In certain embodiments, the MPM can include at least 0.1% by weight of tobermorite phase, and/or at most 55% by weight of tobermorite phase.

In some embodiments, the MPM can include at least 0.1% by weight of hydrogrossular phase, and/or at most 15% by weight of hydrogrossular phase.

In certain embodiments, the MPM can include dicalcium silicate hydrate phase. In such embodiments, the MPM can include up to 20% by weight of dicalcium silicate hydrate phase.

In some embodiments, the MPM can include amorphous phase. In such embodiments, the MPM can include up to 55% by weight of amorphous phase.

In certain embodiments, the MPM can include at least 0.1% by weight of KCl, and/or at most 99% by weight of KCl.

In some embodiments, the MPM can include accessories phase. In such embodiments, the MPM can further include at least 0.1% by weight of accessories phase, and/or up to 20% by weight of accessories phase.

In certain embodiments, the MPM has a salinity index of between 5% and 119%.

In some embodiments, the MPM can include K-feldspar phase in a range of between 1% and 74.5% by weight, tobermorite phase in a range of between 0.1% and 55% by weight, hydrogrossular phase in a range of between 0.1% and 15% by weight, dicalcium silicate hydrate phase in a range of between 0% and 20% by weight, amorphous phase in a range of between 0% and 55% by weight, sylvite phase in a range of between 0.1% and 99% by weight, and accessories phase in a range of between 0.1% and 20% by weight.

In certain embodiments, the MPM can include at most 20% by weight of tobermorite phase, and/or the MPM can include at most 10% by weight of dicalcium silicate hydrate phase.

In some embodiments, the MPM has a cation exchange ratio of at least 10 mmolc/kg.

In certain embodiments, the MPM has a cation exchange ratio of at most 2,000 mmolc/kg.

In some embodiments, a percentage of K+ in the MPM can be between 5% and 55%.

In certain embodiments, the composition can be used as a fertilizer, for soil remediation, to decontaminate soil, to increase crop yield, to improve soil health, and/or to improve soil fertility.

### BRIEF DESCRIPTION OF THE DRAWINGS

Illustrative embodiments of the disclosure are provided below with reference to the drawings, in which:

FIG. 1 depicts an embodiment of a two-step process.

FIG. 2 depicts an embodiment of a process that includes more than two steps.

FIG. 3 shows experimental results when varying the residence time for the second step (EXAMPLE 1).

FIG. 4 shows experimental results when varying the temperature for the second step (EXAMPLE 2).

FIG. 5 shows experimental results when varying the liquid to solid (L:S) ratio for the entire process and the temperature for the second step (EXAMPLE 3).

FIG. 6 shows experimental results when varying the temperature used for the first step (EXAMPLE 4).

FIG. 7 shows experimental results when varying the residence time used for the first step (EXAMPLE 6).

### DESCRIPTION OF ILLUSTRATIVE EMBODIMENTS

FIG. 1 schematically depicts an embodiment for a two-step process 100 of making an MPM. In a first step 102, starting materials are combined in a first reaction vessel and reacted under a first set of conditions for a first period of time to form an intermediate product. In a second step 104, the intermediate product is disposed in a second reaction vessel and heated under conditions to form the MPM.

In general, the starting material includes particles of one or more potassic framework silicates and one or more compounds selected from an alkali metal oxide, an alkali metal hydroxide, an alkaline earth metal oxide, and alkaline earth metal hydroxide, and combinations thereof, followed by contact with water. The starting materials can be added via a continuous process or via a batch process. Contacting the mixture with water can be carried out by any suitable method, such as adding water to the mixture, or by adding the mixture to water, or by sequentially or simultaneously adding the water and mixture to a suitable reaction vessel (see discussion below). In general, any appropriate amount of water can be used. In some embodiments, a weight excess of water relative to the potassic framework silicate starting material is used.

In some embodiments, a potassic framework silicate can be K-feldspar, kalsilite, nepheline, trachyte, rhyolite, ultrapotassic syenite, leucite, nepheline syenite, phonolite, fenite, aplite or pegmatite. Combinations of such potassic framework silicates can be used.

In some embodiments, the one or more compounds selected from an alkali metal oxide, an alkali metal hydroxide, an alkaline earth metal oxide, and alkaline earth metal hydroxide, and combinations thereof include calcium oxide, calcium hydroxide, or mixtures thereof. In some embodiments, the one or more compounds selected from an alkali metal oxide, an alkali metal hydroxide, an alkaline earth metal oxide, and alkaline earth metal hydroxide, and combinations thereof include calcium hydroxide. In some embodiments, the one or more compounds selected from an alkali metal oxide, an alkali metal hydroxide, an alkaline earth metal oxide, and alkaline earth metal hydroxide, and combinations thereof include calcium oxide. In certain embodiments, the one or more compounds selected from an alkali metal oxide, an alkali metal hydroxide, an alkaline earth metal oxide, and alkaline earth metal hydroxide, and combinations thereof include lithium oxide, sodium oxide, potassium oxide, rubidium oxide, cesium oxide, lithium hydroxide, sodium hydroxide, potassium hydroxide, rubidium and/or cesium hydroxide. In some embodiments, the one or more compounds selected from an alkali metal oxide, an alkali metal hydroxide, an alkaline earth metal oxide, and alkaline earth metal hydroxide, and combinations thereof include magnesium oxide, calcium oxide, beryllium oxide, strontium oxide, radium oxide, magnesium hydroxide, calcium hydroxide, beryllium hydroxide, strontium hydroxide, and/or radium hydroxide.

In some embodiments, the mixture includes a calcium-bearing compound and a silicon-bearing compound. In various embodiments of the present disclosure, the ratio of the calcium-containing material (i.e., CaO, Ca(OH)₂, CaCO₃, (Ca,Mg)CO₃, and combinations thereof) to the silicon bearing material (i.e., potassium framework silicate) can be used to modulate the mineralogy, extraction, buffering capacity, as well as other properties of the composition (e.g., an MPM:KCl composition). In some embodiments, the Ca:Si ratio is at least 0.05 and/or at most 4.

As noted above, the starting material can be in the form of coarser and/or finer particles. The particles can be formed by any appropriate process, such as, for example, co-grinding or separately comminuting using methods known in the art, such as crushing, milling, etc. of dry or slurried materials, for example using jaw-crushers, gyratory crushers, cone crushers, ball mills, micronizing mills, rod mills or the like. The resulting mixture can be sized as desired, via sieves, screens, etc. known in the art. In some embodiments, the particles have a mean particle size of from one nanometer to two millimeters.

Generally, the first step 102 is performed at a temperature of at most 100° C. (e.g., at most 90° C., at most 80° C., at most 70° C., at most 60° C., at most 50° C.) and/or at least 20° C.(e.g., at least 25° C., at least 30° C., at least 35° C., at least 40° C.), including ranges therebetween.

In general, the first step 102 is performed at a pressure of most two atmospheres (e.g., at most 1.8 atmospheres, at most 1.5 atmospheres) and/or at least 0.9 atmosphere (e.g., at least one atmosphere, at least 1.1 atmospheres), including ranges therebetween.

In some embodiments, the first step 102 is performed for at least one minute (e.g., at least 15 minutes, at least 30 minutes, at least one hour, at least 10 hours, at least one day, at least two days) and/or at most two weeks (e.g., at most one week, at most six days, at most five days, at most three days), including ranges therebetween. However, in certain embodiments, the time period used for the first step can be different. As an example, if using an evaporation pond (e.g., in a relatively hot and dry environment, such as a desert), the first step can be performed for longer than two weeks (e.g., at least one month).

Generally, the first step 102 can be performed with or without agitation. In an embodiment involving agitation, any appropriate agitation mechanism may be used. Illustrative examples of agitation mechanisms include impellors, mixers, agitators and baffles.

In some embodiments, the first step 102 is performed in a single reaction vessel. In certain embodiments, the first step 102 is performed in a plurality of reaction vessels. Examples of reaction vessels that can be used in the first step 102 include closed tanks, open tanks, containment vessels, open evaporation ponds, tubular vessels such as pipes and rotating drums, rotating disks, solid-liquid contactors such as solid-liquid fluidized beds and hydrocyclones.

In certain embodiments, the first step 102 can include two or more sub steps. The sub steps can include reacting the starting materials at a first temperature to form first materials, followed by heating to react the first materials into the intermediate products. The first temperature can be, for example, at most 50° C. (e.g., between 20° C. and 50° C.), and the second temperature can be, for example, at most 100° C. (e.g., between 50° C. and 100° C.).

In general, the second step 104 involves heating to convert the intermediate materials to the MPM. In some embodiments, the second step 104 includes using a temperature of at least 180° C. (e.g., at least 190° C., at least 200° C., at least 210° C., at least 220° C., at least 230° C., at least 240° C.) and/or at most 400° C. (e.g., at most 350° C., at most 300° C., at most 290° C., at most 280° C., at most 270° C., at most 250° C., at most 240° C.), including ranges therebetween.

Generally, the second step 104 is performed at a pressure of at least five atmospheres (e.g., at least 10 atmospheres, at least 25 atmospheres, at least 50 atmospheres) and/or at most 300 atmospheres (e.g., at most 200 atmospheres, at most 100 atmospheres, at most 75 atmospheres), including ranges therebetween.

Typically, the second step 104 is performed for at least one minute (e.g., at least five minutes, at least 15 minutes, at least 30 minutes, at least one hour, at least 10 hours, at least one day, at least two days) and/or at most two weeks (e.g., at most one week, at most six days, at most five days, at most three days), including ranges there between.

The second step 104 may be performed with or without agitation.

In some embodiments, the second step 104 is performed in a single reaction vessel, which may be different from the one or more reaction vessels used in the first step 102. In certain embodiments, the second step 104 is performed in a plurality of reaction vessels. One or more of the reaction vessels used in the second step 104 may be different from the one or more reaction vessels used in the first step 102. Any reaction vessel appropriate for the used conditions can be implemented in the second step 104. Examples of reaction vessels that can be used in the second step 104 include autoclaves, pipe reactors, screw reactors, and three phase gas-liquid-solid contactors, such as fluidized beds and rotating drums.

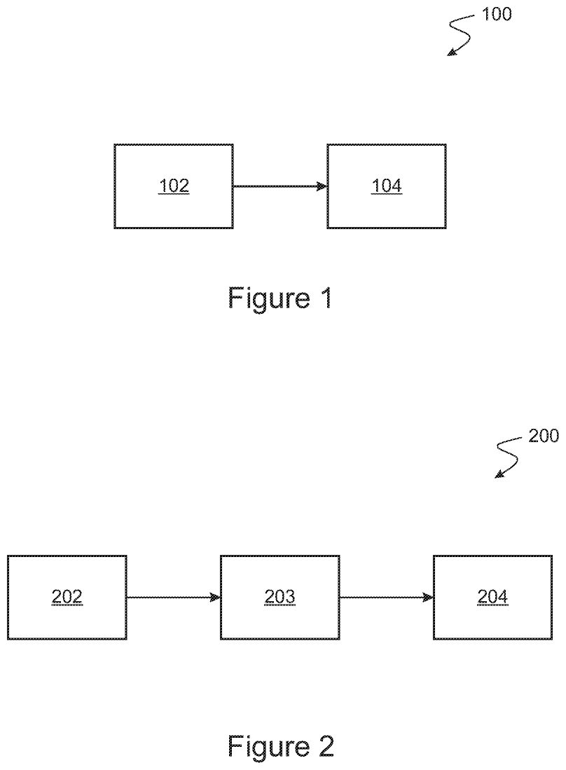

FIG. 2 depicts a method 200 that includes a first step 202 (e.g., similar to that described above with respect to step 102) and a second step 204 (e.g., similar to that described above with respect to step 204). However, the method 200 further includes an additional step 203, which occurs between steps 202 and 204. The step 203 typically involves heating to achieve a temperature between the temperature used in step 202 and the temperature used in step 204, and holding this intermediate temperature for a period of time. In some embodiments, the step 203 includes holding the temperature between at least 20° C. (e.g., at least 25° C., at least 30° C., at least 35° C., at least 40° C.) and at most 400° C. (e.g., at most 350° C., at most 300° C., at most 290° C., at most 280° C., at most 270° C., at most 250° C., at most 240° C.). This temperature can be held for a period of time as desired (e.g., at least 10 minutes, at least 30 minutes, at least one hour, at least 10 hours) and/or at most two days (e.g., at most one day, at most 20 hours). In some embodiments, the step 203 is performed using the same or similar pressure conditions as used in the step 204. In certain embodiments, the step 203 is performed using a pressure that is intermediate between the pressure used for the step 202 and the pressure used for the step 204. Generally, the step 203 can be performed with or without agitation. The step 203 is typically performed using the same reaction vessel(s) that are used in the step 204, although it is an option to use one or more different reaction vessels for the step 203 compared to the step 204.

While FIG. 2 depicts a single intermediate step 203 between the first step 202 and the second step 204, there can be a transition between the conditions of the first step 202 and the second step 204. Thus, it is possible to have more than one intermediate step (e.g., more than two intermediate steps, more than five intermediate steps, more than 10 intermediate steps, more than 100 intermediate steps) between the first step 202 and the second step 204. As an example, in some embodiments, there is a transition (involving more than one intermediate temperatures) between a temperature of at least 20° C. (e.g., at least 25° C., at least 30° C., at least 35° C., at least 40° C.) and at most 400° C. (e.g., at most 350° C., at most 300° C., at most 290° C., at most 280° C., at most 270° C., at most 250° C., at most 240° C.). As another example, in certain embodiments, there is a transition (involving more than one intermediate pressure) between a pressure of at most two atmospheres and a pressure of at least five atmospheres. As a further example, in some embodiments, there is a transition between both: 1) a temperature of at least 20° C. and a pressure of at most two atmospheres; and 2) a temperature of at most 400° C. and a pressure of at most 300 atmospheres. In such embodiments, there are more than one intermediate temperatures between the first step and the second step, and there are more than one intermediate pressures between the first step and the second step. In some embodiments, the transition between the first step and the second step is a smooth transition between one or more (e.g., all) of the conditions of the first step and the conditions of the second step. For example, the temperature can be a smooth transition, and/or the pressure transition can be a smooth transition. In some embodiments, the transition of a condition is monotonic, e.g., a monotonic increase in temperature and/or a monotonic increase in pressure. In certain embodiments, the transition of a condition is a step-wise transition, e.g., a step-wise increase in temperature and/or a step-wise increase in pressure. Other types of transitions are also possible. Generally, the minimum temperature of an intermediate step between the steps 202 and 204 is greater than the temperature is used in the first step 202, and the maximum temperature of an intermediate step is less than the temperature used in the second step 204. In general, the minimum pressure of an intermediate step between the steps 202 and 204 is greater than the pressure is used in the first step 202, and the maximum pressure of an intermediate step is less than the pressure used in the second step 204.

Generally, after formation of MPM according to the steps described above, a drying step is performed. In some embodiments, the drying step can be carried out under ambient temperature (e.g., by allowing the supernatant water to evaporate). In certain embodiments, the drying step is carried out at of at least 25° C. (e.g., at least 50° C., at least 75° C.) and/or at most 400° C. (e.g., at most 300° C., at most 200° C., at most 150° C.), including ranges therebetween. In some embodiments, drying is performed at a pressure of at most 100 atmospheres (e.g., at most 50 atmospheres, at most 25 atmospheres, at most 10 atmospheres) and/or at least one atmosphere (e.g., at least two atmospheres), including ranges therebetween. In some embodiments, drying is performed under an inert atmosphere or under a reactive atmosphere. An inert atmosphere can include, for example a noble gas (e.g., Ar) or N₂. Examples of reactive atmospheres include air, oxygen, carbon dioxide, carbon monoxide, or ammonia. Mixtures of various gases may be used. Generally, the drying step can occur with or without agitation. In certain embodiments, the drying step is performed for a duration of one minute to two days (e.g., one hour to one day).

In general, an MPM includes at least two phases (e.g., at least three phases, at least four phases) selected from K-feldspar phase, tobermorite phase, hydrogrossular phase, dicalcium silicate hydrate phase and amorphous phase. In some embodiments, an MPM includes K-feldspar phase, tobermorite phase, hydrogrossular phase, dicalcium silicate hydrate phase and amorphous phase. In certain embodiments, an MPM includes at least 1% by weight of K-feldspar phase and/or at most 74.5% by weight of K-feldspar phase. In some embodiments, an MPM includes at least 0.1% by weight of tobermorite phase and/or at most 55% by weight of tobermorite phase (e.g., between 0% and 50% by weight, between 0% and 45% by weight, between 0% and 40% by weight, between 0% and 35% by weight, between 0% and 30% by weight, between 0% and 25% by weight, between 0% and 20% by weight). In some embodiments, an MPM includes at least 0.1% by weight of hydrogrossular phase and/or at most 15% by weight of hydrogrossular phase (e.g., from 0.1% by weight to 12% by weight). In certain embodiments, an MPM includes dicalcium silicate hydrate phase in an amount of at most 20% by weight (e.g., at most 10% by weight, at most 15% by weight, at most 12% by weight). In some embodiments, an MPM includes amorphous phase in an amount of at most 55% by weight (e.g., at most 45% by weight). In certain embodiments, an MPM further includes an accessories phase (e.g., in an amount of at least 0.1% by weight and/or at most 20% by weight). In some embodiments, an MPM includes K-feldspar phase in a range of between 1% and 74.5% by weight, tobermorite phase in a range of between 0.1% and 55% by weight, hydrogrossular phase in a range of between 0.1% and 15% by weight, dicalcium silicate hydrate phase in a range of between 0% and 20% by weight, amorphous phase in a range of between 0% and 55% by weight, sylvite phase in a range of between 0.1% and 99% by weight and accessories phase in a range of between 0.1% and 20% by weight. In some embodiments, an MPM includes at most 20% by weight of tobermorite phase, and/or at most 10% by weight of dicalcium silicate hydrate phase.

In some embodiments, an MPM is in the form of particles. Such particles can have, for example, a mean particle size of from one nanometer to two millimeters.

In general, MPM can be used as desired. In some embodiments, MPM is used as a fertilizer (e.g., to provide one or more nutrients to the soil), for soil remediation (e.g., to immobilize one or more heavy metals from the soil), to decontaminate soil (e.g., to remove one or more contaminants from the soil), to increase crop yield, to improve soil health, and/or to improve soil fertility.

### EXAMPLE

Experiments were performed to assess the impact of residence time of both the first and second steps, the impact of temperature for both the first and second steps, and the liquid to solid (L:S) ratio when producing MPM.

The ultrapotassic syenite used in the examples was obtained from the Triunfo batholith, located in Pernambuco State, Brazil. The K-feldspar content was 94.5 wt. %. Hand-sized field samples were comminuted in a jaw crusher, and sieved to obtain particles with size <2 mm. Reagent grade calcium oxide (CaO) was used as received.

The feed mixture (starting materials) was obtained by dry milling ultrapotassic syenite (<2 mm), down to a P90˜150 μm. CaO was added to the K-feldspar rich powder to achieve a nominal Ca:Si molar ratio of 0.3, based on the assumption that there was no Si in the CaO and no Ca in the ultrapotassic syenite.

The first step hydrothermal reaction was studied using a customized findenser setup with a round bottom flask (RBF) and a multifin aluminum heat exchanger for temperature control. Magnetic stirring was performed to ensure efficient mixing during the hydrothermal reaction.

Experiments of the second step were performed within a Swagelok high pressure cylinder with reactor capacity of 150 ml and dimensions of length (end-to-end), diameter and thickness as 12.4, 5.08 and 0.24 cm respectively. The high pressure cylinder was fixed in the horizontal position to provide uniform heating along the length of cylinder with the temperature of the reactor measured in the middle of cylinder. An induction heating setup was employed to heat up the pressure cylinder. The pressure cylinder was inside the induction coil. A controller of the induction power supply controlled the temperature using a type K thermocouple inserted inside the pressure cylinder. The contents of the high pressure cylinder was not mixed throughout this step.

Measurements of potassium (K⁺) availability were performed with a standard leaching test, where 1 g of MPM was mixed with 100 g of 0.1 M nitric acid solution and agitated for 30 minutes. The solution was then filtered using a Whatman filter paper, with the resulting leachate analyzed with ICP-MS (PerkinElmer NexION 300X) in order to verify the wt. % of (K⁺) extracted from the sample. The amount of potassium extracted during the leaching test has been observed to be a good proxy to indicate the amount of conversion that occurred when comparing the MPM to the starting materials (feedstock).

### Example 1

In EXAMPLE 1, the standard feedstock mixture, approximately 52 g, was used for each experiment. Water was added to the RBF together with the feedstock at a L/S ratio of 4:1 and kept at 95° C. for 2 hours (the first step). After this period of time elapsed, a sample of about 30 g of the resulting/intermediary slurry was then inserted into a Swagelok high pressure cylinder, where the intermediate product was then heated to 220° C. and kept under resulting pressure without agitation for a given amount of time (the second step). Four different runs were performed, with an identical first step, but varying residence times for the second step while keeping the pressure and temperature at a set level. After the second step concluded, the resulting slurry was extracted from the pressure vessel and dried in a lab oven at ˜120° C. and atmospheric pressure, after which only dry MPM remained. The resulting MPM was then tested through the standard leaching test.

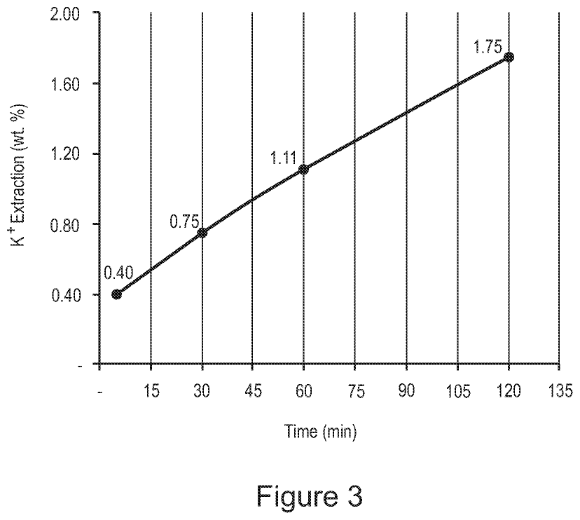

From the MPM sample that was kept at 220° C. for 5 minutes during the second step, 0.40 wt. % of K⁺ was extracted during the leaching test. From the MPM sample kept at 220° C. for 30 minutes during the second step, 0.75 wt. % of K⁺ was extracted during the leaching test. For the sample kept at 220° C. for 60 minutes during the second step, 1.11 wt. % of K⁺ was extracted during the leaching test. From the MPM the sample kept at 220° C. for 120 minutes during the second step, 1.75 wt. % of K⁺ was extracted during the leaching test. The results are summarized in Table I and FIG. 3.

TABLE I

| | Isothermal (@220° C.) Residence Time in Step II | | | |
|---|---|---|---|---|
| | 5 min | 30 min | 60 min | 120 min |
| K extraction | 0.40 | 0.75 | 1.11 | 1.75 |
| (wt. % of K⁺) | | | | |

It was observed that, while keeping the first step the same throughout experiments, an increase in residence time during the second step increased the K⁺ availability of the resulting MPM.

### Example 2

In EXAMPLE 2, the standard feedstock mixture, approximately 52 g, was used for each experiment. Water was added to the RBF together with the feedstock at a L/S ratio of 4:1 and kept at 95° C. for 2 hours (the first step). After this period of time elapsed, a 30 g sample of the resulting/intermediary slurry was inserted into a Swagelok high pressure cylinder, where the intermediate product was then heated to different temperatures for 1 hour (the second step). Four different runs were performed, with the first step being identical, but varying the temperatures and resulting pressures for the second. After the second step concluded, the resulting slurry was extracted from the pressure vessel and dried in a lab oven at ˜120° C. and atmospheric pressure, after which only dry MPM remained. The resulting MPM was then tested through the standard leaching test.

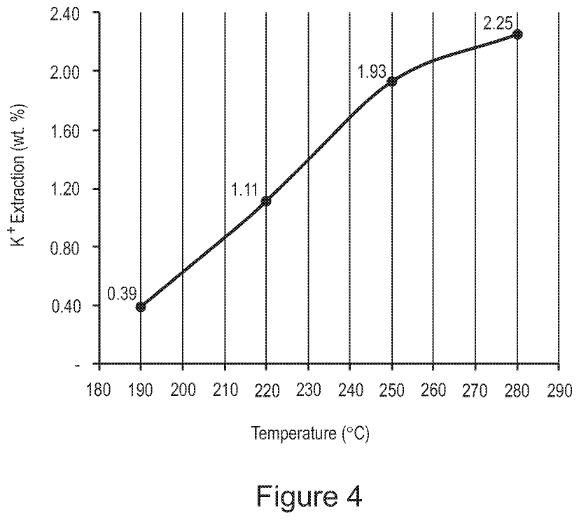

From the MPM sample that was kept at 190° C. for 1 hour during the second step, 0.39 wt. % of K⁺ was extracted during the leaching test. From the MPM sample that was kept at 220° C. for 1 hour during the second step, 1.11% wt. % of K⁺ was extracted during the leaching test. From the MPM sample that was kept at 250° C. for 1 hour during the second step, 1.93 wt. % of K⁺ was extracted. Fr the MPM sample that was kept at 280° C. for 1 hour during the second step, 2.25 wt. % of K⁺ was extracted during the leaching test. The results are summarized in Table II and FIG. 4.

TABLE II

Set Temperature During Step II

| | 190° C. | 220° C. | 250° C. | 280° C. |
|---|---|---|---|---|
| K extraction | 0.39 | 1.11 | 1.93 | 2.25 |
| (wt. % of K⁺) | | | | |

It was observed that, keeping the first step the same throughout experiments, an increase in temperature for the second step increased the K⁺ availability of the resulting MPM.

### Example 3

In EXAMPLE 3, the standard feedstock, approximately 52 g, was used for each run. Both the L:S ratio and the temperature of the second step were varied, totaling 6 experiments. Water was added to the RBF together with the feedstock at 3 different L/S ratios, namely 2:1, 3:1 and 4:1 and kept at 95° C. for 2 hours (the first step). After this period of time elapsed, the resulting slurry was then inserted into a Swagelok high pressure cylinder, where the intermediate product was then heated and kept at either 220° C. or 250° C. for 1 hour (the second step). After the second step concluded, the resulting slurry was extracted from the pressure vessel and dried in a lab oven at ˜120° C. and atmospheric pressure, after which only dry MPM remained. The resulting MPM was then tested through the standard leaching test.

From the MPM sample produced with a L:S ratio of 2:1 and kept at 220° C. for 1 hour during the second step, 0.95 wt. % of K⁺ was extracted during the leaching test. From the MPM sample produced with a L:S ratio of 2:1 and kept at 250° C. for 1 hour, 1.72 wt. % of K⁺ was extracted.

From the MPM sample produced with a L:S ratio of 3:1 and kept at 220° C. for 1 hour during the second step, 1.07 wt. % of K⁺ was extracted during the leaching test. From the MPM sample produced with a L:S ratio of 3:1 and kept at 250° C. for 1 hour during the second step, 1.87 wt. % of K⁺ was extracted during the leaching test.

From the MPM sample produced with a L:S ratio of 4:1 and kept at 220° C. for 1 hour during the second step, 1.11 wt. % of K⁺ was extracted during the leaching test. From the MPM sample produced with a L:S ratio of 4:1 and kept at 250° C. for 1 hour during the second step, 1.93% of K⁺ was extracted during the leaching test.

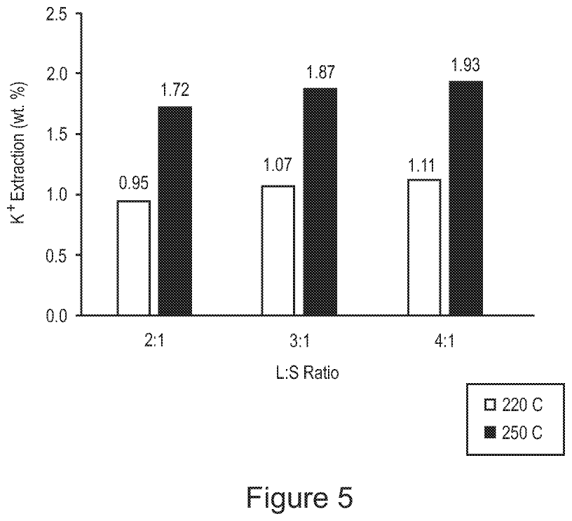

The results are summarized in Table III and FIG. 5.

TABLE III

| | L:S Ratio of 2:1 | | L:S Ratio of 3:1 | | L:S Ratio of 4:1 | |
|---|---|---|---|---|---|---|
| | Temperature | | | | | |
| | 220° C. | 250° C. | 220° C. | 250° C. | 220° C. | 250° C. |
| K extraction | 0.95 | 1.72 | 1.07 | 1.87 | 1.11 | 1.93 |
| (wt. % of K⁺) | | | | | | |

It was observed that a variation of L:S ratio, at least within these boundaries, does not substantially affect the conversion effectiveness of the feedstock. In addition, and as already observed above, an increase in temperature in the second step increased the K⁺ availability of the resulting MPM.

### Example 4

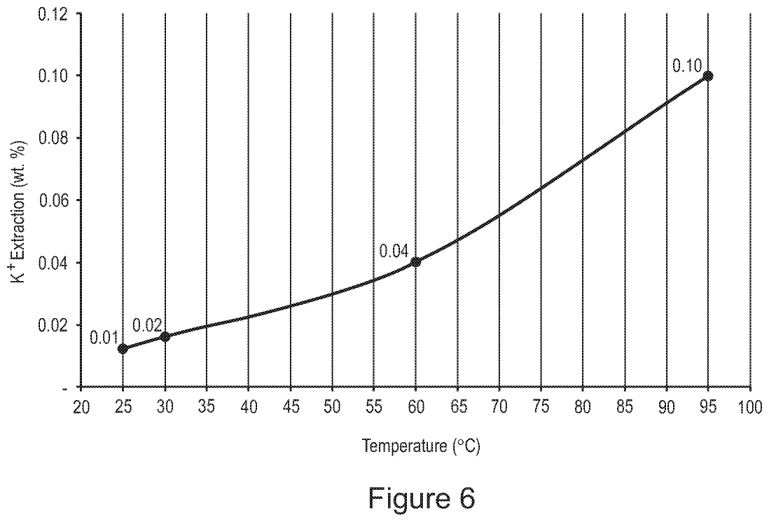

In EXAMPLE 4, the impact of temperature on the first step was also tested. The standard feedstock, approximately 52 g, was mixed with water at 4:1 L:S ratio, stirred and kept at a fixed temperature for 5 hours. Four different temperatures were tested, namely room temperature @ 25° C., 30° C., 60° C. and 95° C., thereby providing four respective intermediate materials. After the 5 hours elapsed at each temperature, the standard leaching test was performed on each of the intermediate materials. The results are summarized in Table IV and FIG. 6.

TABLE IV

| | 5 h Residence Time in Step I @ set Temperature | | | |
|---|---|---|---|---|
| | 25° C. | 30° C. | 60° C. | 95° C. |
| K extraction | 0.01 | 0.02 | 0.04 | 0.10 |
| (wt. % of K⁺) | | | | |

It was observed that increasing the temperature used for the first step increases the availability of K⁺ of the intermediary product produced by the first step.

### Example 5

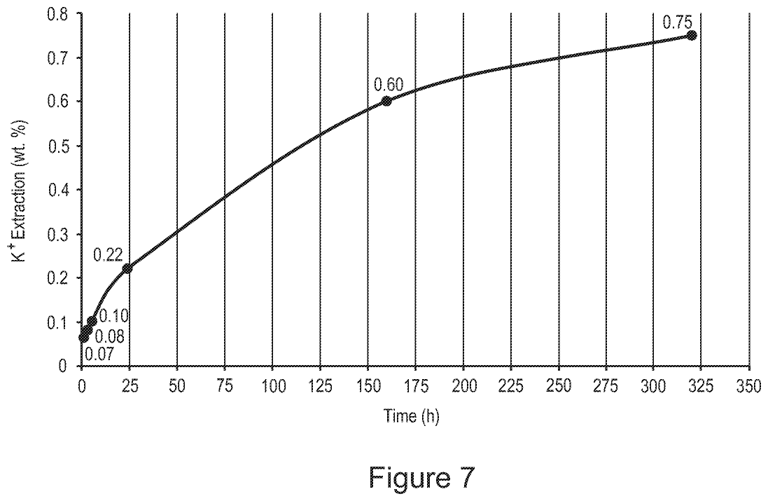

The impact on conversion within the first step was investigated by varying the period of time for the first step, up to 320 hours. The standard feedstock was used and maintained at a L:S ratio of 4:1 and at a temperature of 90° C. (after 24 hours of residence time, the temperature was decreased to 80° C. to avoid excessive evaporation). The results are shown in Table V and in FIG. 7.

The results show that increasing residence time for the first step increases the availability of K⁺ in the intermediate material.

TABLE V

| | Isothermal (@90° C.) Residence Time in Step I | | | | | |
|---|---|---|---|---|---|---|
| | 1 h | 3 h | 5 h | 24 h | 160 h | 320 h |
| K extraction (wt. % of K⁺) | 0.07 | 0.08 | 0.10 | 0.22 | 0.60 | 0.75 |

### Example 6

Mineralogy was determined by X-Ray Powder Diffraction (XRPD), analyzing: (i) the standard feedstock; (ii) the intermediary product after the first step which was performed for 30 minutes at 100° C. with stirring; and (iii) the MPM produced after the second step of the two-step process in which the first step was performed for 300 minutes at 100° C. with stirring, and the second step was performed for 30 minutes 220° C. without stirring. Powder samples were back-loaded onto the sample holder and put into a diffractometer (Panalytical X'Pert MPD) that used CuKα radiation at 45 kVand 40 mA as an X-ray source. Once identified, mineral phases were quantified via the internal standard method and Rietveld refinement. The results are presented in Table VI.

TABLE VI

| | | | | | | | | Di- | | | | | |
|---|---|---|---|---|---|---|---|---|---|---|---|---|---|
| | | | | | | | Plazolite/ | calcium | | | | | |
| | | Experimental | | K- | Bio- | | Hydro- | silicate | Port- | Amor- | | | |
| | Sample | conditions | Albite | feldspar | tite | Tobermorite | grossular | hydrate | landite | phous | Lime | Others | Total |
| 1 | Standard Feedstock | Unprocessed | 5.4 | 69.4 | 0.7 | — | — | — | 2.4 | 13.7 | 8.4 | — | 100.0 |
| 2 | Intermediary product | 30 min @ | 7.8 | 45.2 | 0.8 | — | — | — | 15.4 | 29.3 | — | 1.5 | 100.0 |
| | after step I | 100 C. (stir) | | | | | | | | | | | |
| 3 | MPM - 2 step | 30 min @ | 6.2 | 39.1 | 0.9 | 1.3 | 9.6 | 14.9 | 2.7 | 23.0 | — | 2.3 | 100.0 |
| | process | 100 C. (stir), | | | | | | | | | | | |
| | | 30 min @ | | | | | | | | | | | |
| | | 220 C. (no stir) | | | | | | | | | | | |

By comparing the mineralogy of the intermediary product with the mineralogy of the MPM in Table VI, it is apparent that the significant mineralogical change occurred in the second step. However, by comparing the mineralogy of the intermediary product with the mineralogy of the standard feedstock in Table VI, it is also apparent that a certain level of change already happens in the first step, demonstrated, for example, by an increase of the amorphous phase.

### Other Embodiments

While certain embodiments have been provided, the disclosure is not limited to such embodiments.

As an example, in some embodiments, an MPM can include at least one additional component. Examples of such materials include KCl (sylvite phase), one or more micronutrients (e.g., nitrogen (N), phosphorus (P), potassium (K), calcium (Ca), magnesium (Mg) and sulfur (S)), one or more micronutrients (e.g., boron (B), chlorine (Cl), copper (Cu), iron (Fe), manganese (Mn), molybdenum (Mo), nickel (Ni) and zinc (Zn)) and/or one or more other beneficial elements (e.g., sodium (Na), selenium (Se), silicon (Si), cobalt (Co) and vanadium (V).

In general, the at least one additional component can be introduced as part of any of the processes disclosed herein. In some embodiments, the at least one additional component is added during the first step. In certain embodiments, the at least one additional component is added after the second step. In some embodiments, the at least one additional component is added during an intermediate step. In certain embodiments, the at least one additional component is added after MPM formation but before drying. In some embodiments, the at least one additional component is added after drying.

Generally, a source of an additional component can be used in any appropriate form. Examples of such forms include crystals, salts, powder, liquid (e.g., solution) and/or slurry. An exemplary and non-limiting list of source materials is as follows. Examples of phosphorus (P) sources include phosphate rock (e.g., raw material for phosphate fertilizer production), phosphoric acid (e.g., intermediate product from phosphate fertilizer production chain) and monoammonium phosphate. Examples of nitrogen (N) sources include ammonia and urea. Examples of potassium (K) sources include KCl and sulphate of potash (SOP). Examples of magnesium (Mg) sources include magnesia and dolomitic lime. Examples of sulphur (S) sources include gypsum, sulphur and ammonium sulphate. Examples of calcium (Ca) sources includes gypsum and dolomitic lime. An example of a copper (Cu) source is copper sulphate. Examples of boron (B) sources include borates, borax and boric acid. An example of a zinc (Zn) source is zinc sulphate. An example of a manganese (Mn) source is manganese sulphate. Additional appropriate sources of these and other components are known.

In some embodiments, an MPM can have a cation exchange ratio of at least 10 mmolc/kg and/or at most 2,000 mmolc/kg.

In certain embodiments, a percentage of K⁺ in the MPM is between 5% and 55%.

In certain embodiments, an MPM can have a salinity index of between 5% and 119%.

Certain aspects of reaction methods and materials relating to MPM formation are disclosed in U.S. Pat. No. 9,340,465, U.S. Pat. No. 10,800,712, and international patent application serial No. PCT/IB2021/051351. The disclosure of these documents are incorporated by reference herein. To the extent that subject matter disclosed in these documents is inconsistent with subject matter disclosed in the present application, the present application shall be relied upon to resolve such inconsistencies.

1. A method of making an MPM, comprising:
a) reacting starting materials at a temperature of at most 100° C. to form intermediate products; and
b) reacting the intermediate products at a temperature of at least 180° C.,
wherein the method makes the MPM.

2. A method of making an MPM, comprising:
a) reacting starting materials at a pressure of at most two atmospheres to form intermediate products; and
b) reacting the intermediate products at a pressure of at least five atmospheres,
wherein the method makes the MPM.

3. A method of making an MPM, comprising:
a) reacting starting materials to form intermediate products; and
b) reacting the intermediate products without agitation,
wherein the method makes the MPM.

4.-10. (canceled)

11. The method of any one of the preceding claims claim 1, wherein a) is performed at a temperature of at least 20° C.

12.-17. (canceled)

18. The method of claim 1, wherein a) is performed at a pressure of at most two atmospheres.

19.-20. (canceled)

21. The method of claim 1, wherein b) is performed at a pressure of at least five atmospheres.

22.-25. (canceled)

26. The method of claim 1, further comprising, between a) and b), heating from a temperature of at least 100° C. to a temperature of at least 180° C.

27.-28. (canceled)

29. The method of claim 1, further comprising, between a) and b), increasing the pressure from a pressure of at most two atmospheres to a pressure of at least five atmospheres.

30.-31. (canceled)

32. The method of claim 1, wherein a) is performed in a first reaction vessel, and b) is performed in a second reaction vessel different from the first reaction vessel.

33. (canceled)

34. The method of claim 1, wherein a) comprises agitating the starting materials, or a) does not comprise agitating the starting materials.

35. (canceled)

36. The method of claim 1, wherein b) comprises agitating the reaction products, or b) does not comprise agitating the reaction products.

37.-39. (canceled)

40. The method of claim 1, wherein a) is performed for at least 15 minutes, and/or a) is performed for at most two weeks.

41.-43. (canceled)

44. The method of claim 1, wherein b) is performed for at least one minute, and/or b) is performed for at most 24 hours.

45.-47. (canceled)

48. The method of claim 1, wherein a) comprises:
a1) reacting the starting materials at a first temperature of at most 50° C. to form first materials; and
a2) after a1), reacting the first materials at a second temperature which is greater than the first temperature to form the intermediate products.

49.-51. (canceled)

52. The method of claim 1, further comprising, after b), drying the products of b).

53.-56. (canceled)

57. The method of claim 1, wherein the starting materials comprise a potassic framework silicate ore.

58. The method of claim 1, wherein;
the starting materials comprise at least one member selected from the group consisting of K-feldspar, kalsilite, nepheline, phlogopite, muscovite, biotite, trachyte, rhyolite, micas, ultrapotassic syenite, leucite, nepheline syenite, phonolite, fenite, aplite and pegmatite; and/or
the starting materials comprise at least one material selected from the group consisting of an oxide, a hydroxide, and a carbonate of at least one of an alkaline earth metal and an alkali metal

59.-72. (canceled)

73. The method of claim 1, wherein the MPM comprises at least two phases selected from the group consisting of K-feldspar phase, tobermorite phase, hydrogrossular phase, dicalcium silicate hydrate phase and amorphous phase.

74.-92. (canceled)

93. The method of claim 1, wherein the MPM comprises K-feldspar phase in a range of between 1% and 74.5% by weight, tobermorite phase in a range of between 0.1% and 55% by weight, hydrogrossular phase in a range of between 0.1% and 15% by weight, dicalcium silicate hydrate phase in a range of between 0% and 20% by weight, amorphous phase in a range of between 0% and 55% by weight, sylvite phase in a range of between 0.1% and 99% by weight and accessories phase in a range of between 0.1% and 20% by weight.

94.-97. (canceled)

98. The method of claim 1, further comprising using the composition:
as a fertilizer;
for soil remediation;
to decontaminate soil:
to increase crop yield;
to improve soil health; and/or
to improve soil fertility.

99.-102. (canceled)
